(19) United States
(12) Patent Application Publication
(10) Pub. No.: US 2001/0030818 A1
(43) Pub. Date: Oct. 18, 2001

(54) Optical router including bistable optical switch and method thereof

(76) Inventors: Rodney L. Clark, Gurley, AL (US); Jay A. Hammer, Huntsville, AL (US); John R. Karpinsky, Starkville, MS (US)

Correspondence Address: BIRCH STEWART KOLASCH & BIRCH, PO BOX 747, FALLS CHURCH, VA, 22040-0747, US

(21) Appl. No.: 09/752,831

(22) Filed: Jan. 3, 2001

Related U.S. Application Data
(60) Provisional application No. 60/174,164, filed on Jan. 3, 1999.

(51) Int. Cl. G02B 5/08; G02B 7/182

(52) U.S. Cl. 359/877; 359/850; 359/871

(57) ABSTRACT

A bistable optical micro-switch controls the routing of an optical beam. The micro-switch has at least one optical micro-element, which is stable through electrical power interrupts, for directing the optical beam. A change in the state of the optical micro-element is effected by a vertical micro-actuator, which is biased by a micro-spring. A micro-latch can be used to keep the tensed micro-spring from un-tensing when electrical power is interrupted. A micro-latch holds the micro-element in at least one mechanically tensed, stable state.

### CROSS REFERENCE TO RELATED APPLICATIONS

This application claims priority under 35 U.S.C. §119(e) of provisional application U.S. Ser. No. 60/174,164 filed on Jan. 3, 2000, the entire contents of which are hereby incorporated by reference. This application is related to U.S. application Ser. No. 09/049,121, filed on Mar. 27, 1998, the entire contents of which are hereby incorporated by reference.

### FIELD OF THE INVENTION

The present invention is directed to a technique for routing optical beams using micro-structures.

### DESCRIPTION OF THE RELATED ART

Optical switching has many applications in data communication, data processing, and data recording. Typically, the main obstacles to wider use of optical switching are cost, complexity, and reliability. Different techniques for optical switching have been used, including liquid crystal and piezo-electric technologies.

Current Liquid Crystal Display (LCD) devices have limited bandwidth. They suffer from limited fill factor. They also have inadequate dynamic range.

Stacked piezoelectric structures (“SPZT”) utilize a new generation of piezoelectric technology that costs less and features the best advantages of switches/actuators made from piezoelectric (“PZT”) or lead manganese niobate (“PM”) technologies. However, current SPZT devices suffer from high current operation, significant actuator nonuniformity, heavy weight, relatively high power dissipation, and moderate hysteresis effect. Moreover, these devices are relatively expensive when compared to LCD devices. In both approaches, the liquid crystal and piezoelectric, optical activities are deleteriously affected by power interruptions.

### SUMMARY OF THE INVENTION

In a non-limiting implementation of the invention, optical beams are controllably routed using at least one bistable optical micro-switch, the optical micro-switch including at least one optical micro-element and a vertical micro-actuator. The inventive approach places at least one optical micro-element (e.g., a planar or curved mirror, or a lens) on a platform displaced by a bistable vertical micro-actuator to control the directing of optical beams. More particularly, the direction of optical beams is controlled by at least one optical micro-element that is placed on a vertical micro-actuator; the actuator being biased by at least one micro-spring; and the combination of the micro-element and the micro-actuator being selectively held in place by a micro-latch.

The inventive approach has the advantage of using relatively lightweight micro-structures, manufacturable by integrated circuit processing technology, to control the directing of optical beams. Moreover, these micro-structures are simple, have high dynamic range, are highly predictable and repeatable in their performance, and do not suffer from hysteresis. The inventive approach, in a simple and inexpensive manner, can be used to control the directing of at least one optical beam into plural inputs in a bistable manner and, therefore, in a manner immune to power interruptions. The inventive approach routes optical beams consuming low power and using low voltage signals.

In this disclosure, a micro-component (including, but not limited to, actuator, spring, mirror, lens, interdigitated fingers, arm, patch, base, and latch) refers to a component having dimensions suitable for manufacturing using semiconductor device fabrication techniques (including but not limited to MEMs fabrication or micro-machining).

### BRIEF DESCRIPTION OF THE DRAWINGS

Other aspects and advantages of the present invention will become apparent upon reading the detailed description and accompanying drawings given hereinbelow, which are given by way of illustration only, and which do not limit the present invention, wherein:

FIG. 1 is a schematic of controllably routing optical beams using at least one bistable optical micro-switch.

FIG. 2(A) is a top view of a micro-actuator according to an implementation of a preferred embodiment of the present invention;

FIG. 2(B) is a cross sectional view of a micro-actuator according to an implementation of a preferred embodiment of the present invention;

FIG. 3(A) is a schematic showing the micro-latch not engaged according to an implementation of a preferred embodiment of the present invention;

FIG. 3(B) is a schematic showing the micro-latch engaged according to an implementation of a preferred embodiment of the present invention;

FIG. 4(A) is a timeline of the normal operation of the optical router according to an implementation of a preferred embodiment of the present invention;

FIG. 4(B) is a timeline of the operation of the optical router according to an implementation of a preferred embodiment of the present invention when there is an electrical power interruption;

FIG. 5 is a schematic of an implementation of a preferred embodiment of the present invention using a single micro-switch including a planar reflecting mirror as the optical micro-element; and

FIG. 6 is a schematic of an implementation of a preferred embodiment of the present invention using a two by two array of optical micro-switches, each including a planar reflecting mirror as the optical micro-element.

### DETAILED DESCRIPTION

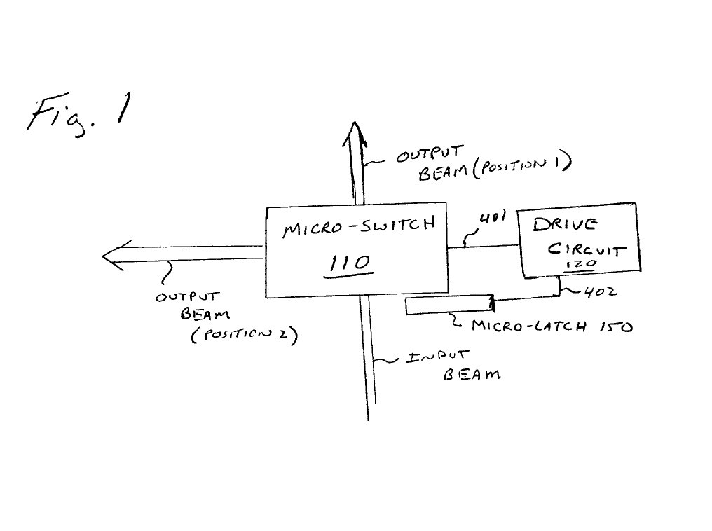

In a preferred embodiment, the inventive approach controllably routes optical beams using at least one bistable optical micro-switch. As exemplified by FIG. 1, this embodiment includes an optical micro-switch 110 (having two positions that are operatively stable; one position is mechanically quiescent and the other position is electrically activated), a micro-latch 150, and a drive circuit 120 providing electrical power and signals. According to this embodiment, an optical beam 100 is directed by the optical micro-switch 110 being in one of its two stable positions (e.g., up position). The optical beam 100 continues in its original direction when the micro-switch 110 is in the other stable position (e.g., down position). According to the present invention, regardless of electrical power interruptions, the optical micro-switch 110 stays in either of its two operating positions in a stable manner.

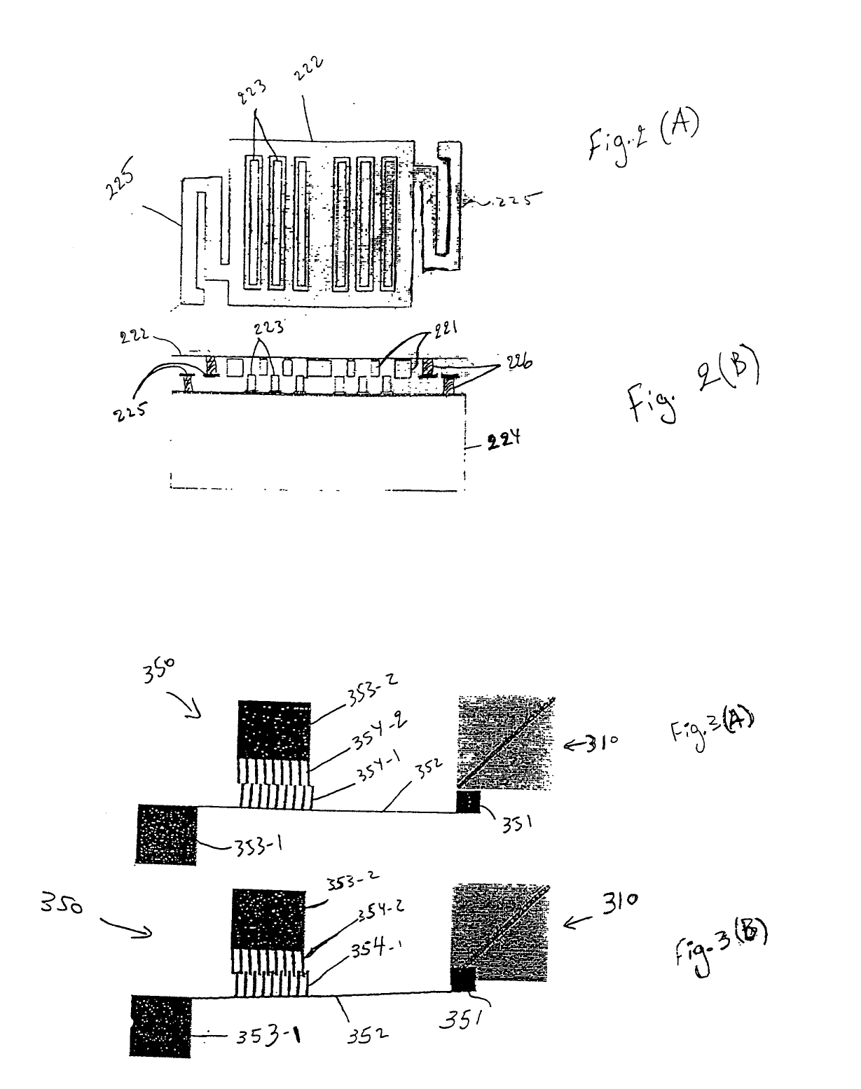

In a preferred embodiment of the present invention, an optical micro-element is operatively connected to (e.g., directly, or indirectly, supported by) a vertical micro-actuator to form the optical micro-switch 110. FIGS. 2(A) and 2(B) show a top view and a cross sectional view, respectively, of an exemplary implementation of a vertical micro-actuator according to a preferred embodiment of the present invention. In the implementation shown in FIGS. 2(A) and 2(B), a micro-actuator includes at least one upper interdigitated micro-finger(s) 221 connected to a platform 222 on which is placed the optical micro-element (not shown in FIG. 2); at least one lower interdigitated micro-finger(s) 223 connected to support 224; and plural micro-springs 225, wherein a micro-spring has at least one end 225-1 connected to the platform 222 through a spacer 226 and has at least another end 225-2 connected to the support 224 through another spacer 226. The optical micro-element is grown on, or attached to, the platform 222. The optical micro-element (not shown in FIG. 2) on the platform 222 is free from attachments to any component other than the platform 222 of the micro-actuator.

The micro-actuator according to the present invention can be implemented by having more than, or less than, two sides of the platform 222 and the support 224 connected to micro-springs. The micro-actuator according to the present invention can be implemented by having more than one micro-spring connected to a side of a platform. For example, two micro-springs can be used to connect a side of the platform 222 with a side of the support 224; a single spring with two connections at each end can be used to connect a side of the platform 222 with a side of the support 224; two springs joined at each end can be used to connect a side of the platform 222 with a side of the support 224; or a combination thereof. The micro-actuator according to the present invention can be implemented using shapes other not four-sided, including triangular, pentagonal, hexagonal, circular, and non-uniform shapes. Instead of using two sets of interdigitated micro-fingers, the micro-actuator according to the present invention can also be implemented using a single rod in a housing.

In an implementation of another preferred embodiment of the present invention, the micro-spring spacers 226 can be chosen to avoid having the upper and lower sections of the micro-actuator be at the same electrical potential. The micro-actuators can be manufactured according to integrated circuit fabrication techniques (including, but not limited to, MEMs fabrication and micro-machining). The micro-actuators can be fabricated using polycrystalline silicon, single crystal silicon, or metallic material.

In the embodiment shown in FIGS. 2(A) and 2(B), the micro-actuator is in the up position (the mechanically quiescent position) when it is electrically not biased because the micro-springs 225 prefer a mechanically quiescent state that minimizes the stored mechanical energy in the micro-springs 225. The micro-actuator is in the down state when there is an electrical potential difference between the upper and lower interdigitated micro-fingers (221 and 223, respectively) of the micro-actuator. In this case, the upper and lower interdigitated micro-fingers (221 and 223, respectively) tend to maximize their overlapped areas to minimize the stored electrical energy--this tendency is opposed by the mechanical energy stored in the stretched micro-springs.

In an implementation of another preferred embodiment of the present invention, the micro-actuator is in the down position when it is electrically not biased and therefore the upper and lower interdigitated micro-fingers overlap; the down state being the mechanically quiescent state. To have the micro-actuator go into the up state, the upper and lower interdigitated micro fingers of the micro-actuator are charged to the same nonzero electrical potential. In this situation, the upper and lower interdigitated micro-fingers repel each other to minimize their overlapped areas and, thus, to minimize the stored electrical energy—this tendency is opposed by the mechanical energy stored in the stretched micro-springs.

Based on the principles of the present invention herein disclosed, on skilled in the art can implement the micro-actuators using arrangements that are non-electric field based. As a non-limiting example, the micro-actuator can be implemented using arrangements reacting to changing magnetic fields. Based on the principles disclosed in the present invention, moreover, one skilled in the art can use other means for providing mechanically quiescent positions. As a non-limiting example, magnetic or gravitational forces, instead of the micro-springs, can be used to achieve the mechanically quiescent position. In a preferred embodiment, the micro-actuator is implemented as a micro-comb drive. In an implementation of this preferred embodiment, the micro-actuator is implemented as a vertical micro-comb drive.

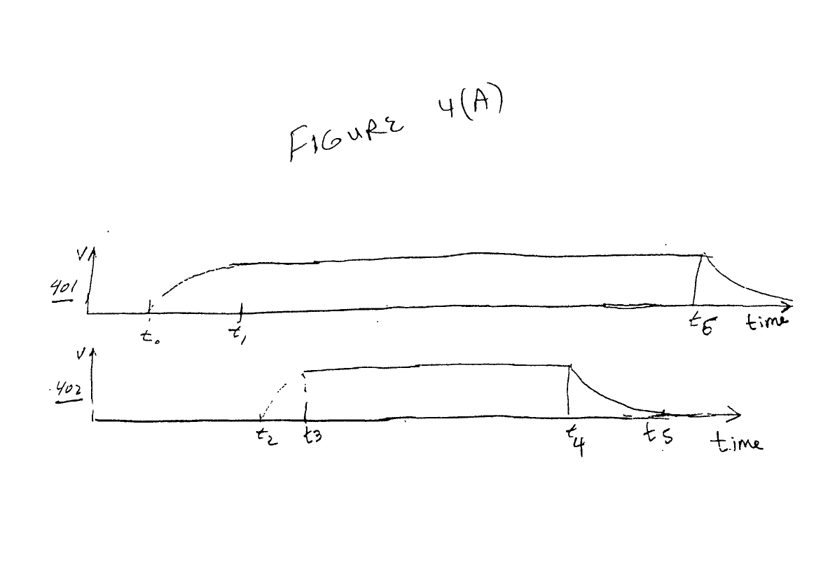

The inventive approach achieves an electric power independent operation by having the micro-switches perform in bistable manner. FIGS. 3(A) and 3(B) show top view schematics of an exemplary lateral micro-latch 350 according to a preferred embodiment of the present invention in a released position and an engaged position, respectively. The lateral micro-latch 350 includes a micro-pad 351 (which acts as a pawl or a tang) connected to micro-arm 352, which is connected to a first micro-base 353-1. The micro-arm 352 is connected to a first set of interdigitated micro-fingers 354-1. There is also a second set of interdigitated micro-fingers 354-2 that is connected to a second micro-base 354-2. The micro-latch 350 according to the present invention can be manufactured according to integrated circuit fabrication techniques and can be made of single crystal, or polycrystalline, silicon or metal.

FIG. 3(A) shows the situation where the interdigitated micro-fingers 354-1 and 354-2 are not charged and, therefore, the spring action of the micro-arm 352 and the micro-base 353-1 keeps the micro-pad 351 from being in the path of the micro-switch 310. FIG. 3(B) shows the situation where the interdigitated micro-fingers 354-1 and 354-2 have a potential difference and, therefore, the micro fingers 354-1 and 354-2 overlap to minimize the stored electrical energy stored as balanced by the spring action of the micro-arm 352 and micro-base 353. The overlapping action of the interdigitated micro-fingers 354-1 and 354-2 pulls the micro-pad 351 into the path of the optical micro-switch 310. In this implementation, the interdigitated micro-fingers 354-1 and 354-2 may have a curving profile to allow their unimpeded angular motion.

According to another preferred embodiment implementing the inventive approach, the situation of FIG. 3(A) is used along with the micro-switch being in the up position when the interdigitated micro-fingers of the micro-actuator are not charged. In this implementation, it is not necessary to have the micro-latch 350 engage the micro-switch 310 to maintain the up position of micro-switch independent of electrical power. In this implementation, the situation of FIG. 3(B) is used when the micro-switch is in the down position as a result of the interdigitated micro-fingers of the micro-actuator fingers being charged to a potential difference. In this situation, the micro-latch 350 is in a position that can engage the micro-switch 310 and therefore can keep it from going into the up position when the electrical power is interrupted. When engaged, the frictional force between the micro-pad 351 and micro-switch 310 stops the micro-latch 350 from disengaging.

In this implementation, the micro-switch 310 (either the micro-actuator or the micro-element, or both) moves to the down position first and then is followed by the micro-latch 350 moving into the engaging position. If the micro-switch 310 is to selectively move into the up position from a down position, then the micro-latch 350 is moved into the disengaging position first and then is followed by the micro-switch 310 moving into the up position.

In this implementation, the circuit that drives the micro-switch 310 to move up has a trigger time that is longer than the trigger time of the circuit that disengages the micro-latch 350; thus allowing the micro-latch 350 to disengage before the micro-switch 310 is allowed to move up. Moreover, in this implementation, the circuit that drives the micro-switch 350 to move down has a trigger time that is shorter than the trigger time of the circuit that engages the micro-latch 350; thus allowing the micro-latch 350 to engage after the micro-switch 310 is allowed to move down.

Furthermore, in this implementation, although the micro-pad 351 are selectively driven to be in the path of the micro-switch, the micro-pad 351 does not physically contact the micro-switch 310 (i.e., the micro-pad neither contacts the micro-actuator nor the micro-element) unless the micro-switch 310 is in the down position and the electrical power is interrupted. Consequently, the micro-latch 350 can continuously operate without wear unless there is an excessive number of power interrupts.

According to another preferred embodiment, the micro-latch is implemented using a micro-comb-drive.

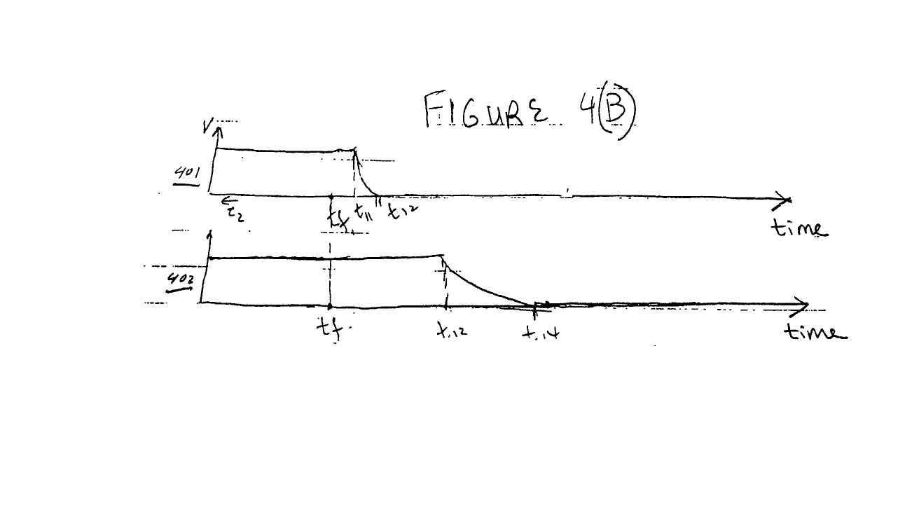

FIGS. 4(A) and 4(B) show a non-limiting implementation of the timelines in a preferred embodiment for the normal operation of the optical router wherein the micro-latch contacts the optical micro-switch (the micro-element or the micro-actuator, or both) only when electrical power is interrupted. FIG. 4(A) shows the timeline of the activation of the micro-switch as driven by the signal on line 401 and the micro-latch as driven by the signal on line 402 during normal operation wherein the micro-switch goes from the up state (mechanically quiescent) to down state (electrically activated) and then back into the up state. At time to a signal is applied to the micro-switch to begin driving it into the down state. At time t₁ the micro-switch is in the down state. At time t₂ a signal is applied to the micro-latch to begin driving it into the path of the micro-switch. At time t₃ the micro-latch is in the path of the micro-switch but does not contact it because the micro-switch is already in the down state.

In one embodiment, the power remains until it is desired to change the state of the optical micro-switch from the down state to the up state whereupon at time t₄ a signal is applied to the micro-latch to begin driving it out of the path of the micro-switch. At time t₅ the micro-switch is out of the path of the micro-switch. At time t₆, a signal is applied to the micro-switch to begin driving it into the up state without the micro-latch being in the path of the micro-switch.

The timeline in the event of an electrical interruption is schematically shown in FIG. 4(B), wherein the micro-switch is in the down position (mechanically tensed) and the micro-latch is in the path of the micro-switch. At time t_{f} electrical power is interrupted. At time t₁₁, as supplied on line 401, the electrical signal maintaining the state of the optical micro-switch begins to decay and the micro-switch begins to go up responding to the unbalanced mechanical force. However, the drive circuit 120 is configured to ensure that the electrical signal, as supplied on line 402, maintains the position of the micro-latch (e.g., the micro-pad) in the path of the micro-switch. The voltage on line 402 begins to decay at a later time t₁₃, which is after the time t₁₂ when the micro-switch contacts the micro-latch. The micro-latch is, therefore, maintained in the path of the now moving micro-switch. At contact, the micro-latch holds the micro-switch in its mechanically tensed state. The micro-latch may be retained in the latching position by friction force or an implementation of an interlocking mechanism such as fingers or hooks provided on the micro-pad 351. When electrical power is recovered, the micro-switch and the micro-latch are electrically activated as in FIG. 4(A).

In the embodiments described in the present disclosure, the micro-latch 350 (e.g., the micro-pad 351) can be implemented to contact the optical micro-element or the micro-actuator, or both.

The micro-latch 350 according to the present invention can also be implemented to have the interdigitated micro-fingers 354-1 and 354-2 repulse each other. For example, the interdigitated micro-fingers 354-1 and 354-2 can be arranged to normally overlap when they are not charged. In this implementation, when the same potential is applied to both of the interdigitated micro-fingers 354-1 and 354-2, then the micro-arm 352 and the micro-pad 351 are pushed away from the normal position and, thus, the micro-pad 351 moves out of the path of the micro-switch 310.

Based on the principles of the invention as herein presented, the micro-latch 350 can also be implemented in other arrangements. For example, in an implementation, the micro-pad 351 is placed on the same side of the micro-arm 352 as the first micro-base 353-1, and the second micro-base 353-2 and the interdigitated micro-fingers 354-1 and 354-2 are placed on the other side of the micro-arm 352 from the first micro-base 353-1. In another implementation, the micro-pad 351 is placed on the other side of the micro-arm 352 from the first micro-base 353-1, and the second micro-base 353-2 and the interdigitated micro-fingers 354-1 and 354-2 are placed on the same side of the micro-arm 352 as the first micro-base 353-1. In yet another implementation, the micro-pad 351, the second micro-base 353-2, and the interdigitated micro-fingers 354-1 and 354-2 are placed on the other side of the micro-arm 352 from the first micro-base 353-1. According to the inventive principles herein disclosed, the choice of whether a potential difference is applied between the interdigitated micro-fingers 353-1 and 353-2 (or whether they are charged up by the same electric potential) depends on whether the micro-pad 351 is to move into, or out of, the path of the micro-switch 310.

In the exemplary implementations of the preferred embodiments described below, a micro-switch includes at least one optical micro-element and at least one micro-actuator as described above. Without being limitative, a micro-actuator in the exemplary embodiments described below is arranged as in FIG. 2(A) with the micro-springs being non-tensed when the micro-switch is in the up position. Other arrangements for the micro-actuator can be used in the exemplary embodiments described below without departing from the invention herein disclosed.

According to a preferred embodiment of the present invention, a micro-actuator arrangement is chosen to minimize the overall time the micro-spring is placed in tension. This is achieved, for example, by determining the most frequent routing direction of an optical beam and choosing an arrangement for the micro-switch (the micro-element) that achieves this routing without the need for tensing the micro-spring—which arrangement therefore is stable if electrical power is interrupted. However, one skilled in the art can also choose to fabricate the router using the arrangement that is most easily, or economically, manufacturable.

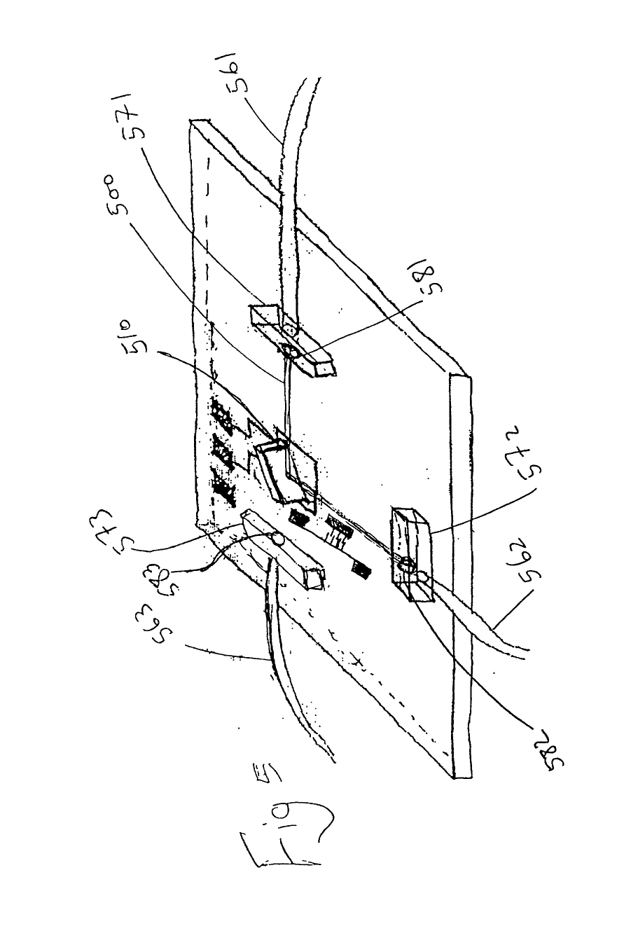

In a preferred embodiment implementing the present invention, a planar reflecting surface is used as the micro-optical element deflecting the optical beam. FIG. 5 shows a schematic of an exemplary preferred embodiment according to the present invention wherein a single bistable micro-switch controls the routing of an optical beam to two receivers. In FIG. 5, an optical micro-switch 510 in the up position routs an optical beam 500 delivered from an optical fiber 561. The fiber 561 is held in place by a fiber holder 571 that has a micro-lens 581 placed between the fiber 561 and the micro-switch 510. The micro-switch 510 in the up position routs the optical beam 500 to optical fiber 562, which is held in place by holder 572, through micro-lens 582. If the micro-switch 510 is in the down position, then it routs the optical beam 500 to optical fiber 563, which is held in place by holder 573, through micro-lens 583. At least one micro-latch, as described above, can be actuated to a position that fixes the state of the micro-switch to the down position if electrical power is interrupted. In this exemplary embodiment, the micro-latch is in a state that would not impede the motion of the micro-switch 510 when it is in the up position. The appropriate arrangement of the micro-latch depends on the specific choice for the micro-actuator arrangement as described above.

In this exemplary embodiment, the micro-switch 510 includes at least one micro-mirror as the optical micro-element. The micro-mirror is a planar surface with a coating deposited on it. The coating is highly reflective to the wavelength of the optical beam. In one implementation, the coating material is gold, which is generally highly reflective for a wide range of wavelengths. Other coating material can be used, including multi-layer coating designed for specific wavelength(s) of the optical beam.

In another preferred embodiment implementing the present invention, a concave reflecting surface is used as the micro-optical element deflecting the optical beam. In this embodiment, micro-lenses 581 and 582 are not necessary since the concave micro-mirror performs the focusing task of the micro-lenses 581 and 582. In a non-limiting implementation of the embodiment described by FIG. 5, the micro-mirror is arranged so that an incident optical beam that is perpendicular to the direction of the motion of the micro-actuator is deflected into another direction that is also perpendicular to the direction of the motion of the micro-actuator. This embodiment can also be implemented using micro-lenses 581 and 582.

The implementation of the preferred embodiment depicted in FIG. 5 has the micro-lenses located on the other side of the fiber holders from the fiber input. However, the micro-lenses in the embodiment exemplified in FIG. 5, as well as in the embodiments depicted later in the disclosure, can be placed anywhere between the fiber holder and the corresponding optical micro-element.

The invention herein disclosed can also be implemented in embodiments using plural optical micro-switches to control the routing of optical beams. For example, an array of M by N (including M or N being equal to 1) micro-switches can be used to control the routing of the optical beam(s).

In the embodiments (earlier or later) describing the present invention, the arrangement of the fibers, the micro-lenses (if used), and the optical micro-element is such that the deflected beam is still efficiently collected into the target fiber during the motion of the optical micro-element from the mechanically tensed situation to where the micro-latch contacts the micro-element (or the micro-actuator) and, thus maintains the mechanically tensed state.

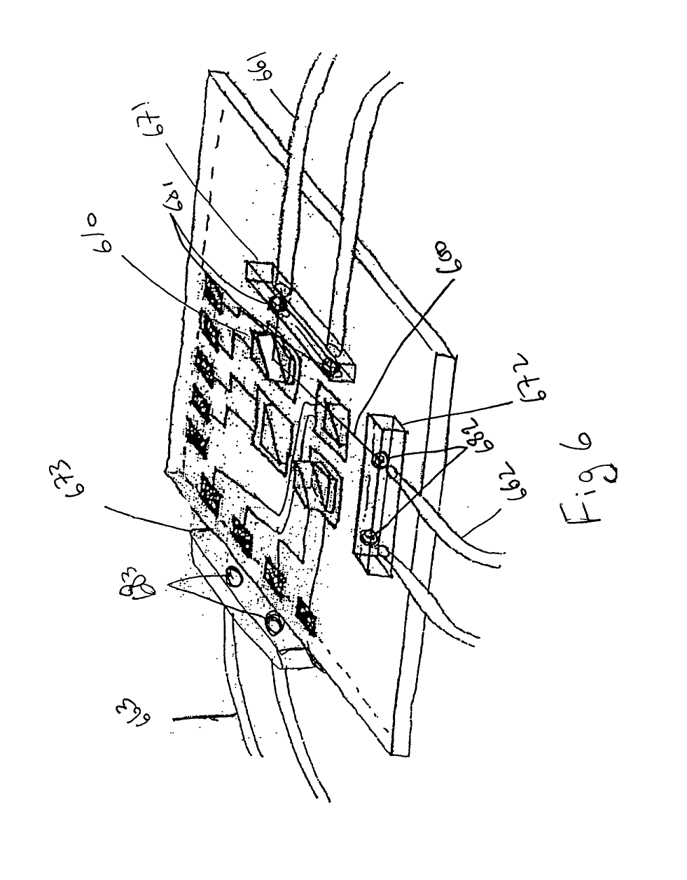

FIG. 6 shows a schematic of a preferred embodiment according to the present invention wherein a two by two array of optical micro-switches are used to control the routing of optical beams. In FIG. 6, a micro-switch 610 in the up position routs an optical beam 600 delivered from an optical fiber 661. The fiber 661 is held in place by a fiber holder 671 that has a micro-lens 681 placed between the fiber 661 and the micro-switch 610. The micro-switch 610 in the up position routs the optical beam 600 to optical fiber 662, which is held in place by holder 672, through micro-lens 682. If the micro-switch 610 is in the down position, then it routs the optical beam 600 to optical fiber 663, which is held in place by holder 673, through micro-lens 683. At least one micro-latch, as described above, can be actuated to a position that fixes the state of the micro-switch to the down position if electrical power is interrupted. In this exemplary embodiment, the micro-latch is in a state that would not impede the motion of the micro-switch 610 when it is in the up position. The appropriate arrangement of the micro-latch depends on the specific choice for the micro-actuator arrangement as described above.

In this exemplary embodiment, micro-switch 610 includes at least one micro-mirror as the optical micro-element. The micro-mirror is a planar surface with a coating deposited on it. The coating is highly reflective to the wavelength of the optical beam. In one implementation, the coating material is gold, which is generally highly reflective for a wide range of wavelengths. Other coating material can be used, including multi-layer coating designed for specific wavelength(s) of the optical beam.

In another preferred embodiment implementing the present invention, a concave reflecting surface is used as the micro-optical element deflecting the optical beam. This embodiment differs from that of FIG. 6 in using a concave reflective micro-mirror instead of a plane reflective micro-mirror. In this embodiment, micro-lenses 681 and 682 are not necessary since the concave micro-mirror performs the focusing task of the micro-lenses 681 and 682. In a non-limiting implementation of the embodiments described by FIG. 6, the micro-mirror is arranged so that an incident optical beam that is perpendicular to the direction of the motion of the micro-element is deflected into another direction that is also perpendicular to the direction of the motion of the micro-element.

The embodiments of the invention using plural optical micro-switches can be implemented using a mixture of planar and concave mirrors as the at least one optical micro-elements included in each micro-switch. For example, in the embodiment exemplified by FIG. 6, one of the micro-elements can be implemented as a planar micro-mirror and another micro-element can be implemented as a concave micro-mirror, with the appropriate choice for providing micro-lenses.

The implementation of the invention can be extended to a two dimensional arrangement of M by N micro-switches where at least one of M and N is greater than 2. The present invention can also be implemented in two dimensional geometries using plural rows of micro-switches wherein at least two of the rows have different number of micro-switches. For example, the invention can be implemented using five micro-switches arranged so that a first row has 3 micro-switches and a second row has two micro-switches.

The invention herein disclosed is not limited in its implementation to the M by N rectangular equidistant distribution of optical micro-switches. Rather, the invention can be implemented using different geometries for the arrangement of the optical micro-switches including, but not limited to, rectangular arrays with different distances between at least two of the micro-switches, triangular, pentagonal, and hexagonal arrangement of micro-switches.

The present invention can also be implemented using other imaging components in addition to, or instead of, the micro-lenses to direct the optical beams to the fibers.

The preferred embodiments of the present invention, described, above implemented the router so that only when there is a power interrupt does the micro-latch contact the optical micro-element (or the micro-actuator) and, thus, make the optical micro-optical element hold its state. In another preferred embodiment, the micro-latch is arranged to contact the optical micro-element (or the micro-actuator, or both) when the micro-spring is in the tensed condition and, thus, electrical power may be intentionally removed according to the signals of FIG. 4(B) without affecting the state of the optical micro-element. In this embodiment, the electrical power is turned back on according to the signals of FIG. 4(A) just before the micro-switch is to be intentionally driven to the up (mechanically quiescent) state. Thus, when the power is turned off according to the second half of FIG. 4(B) the micro-latch disengages its contact with the optical micro-element (or the micro-actuator) before the micro-switch is moved. This embodiment allows one to use short electrical signals to affect the router function, without having to maintain the electrical power when routing states are not changed.

Although the present invention has been described in considerable detail with reference to certain exemplary embodiments, it should be apparent that various modifications and applications of the present invention may be realized without departing from the scope and spirit of the invention. Scope of the invention is meant to be limited only by the claims.

We claim:

1. An optical router comprising:
an optical micro-element having plural operable states, said optical micro-element actuatable to change operable states, wherein a change in the operable state of said optical micro-element changes the direction of an optical beam; and
a micro-latch having plural conditions, said micro-latch actuatable to change conditions, one of said conditions maintaining the operable state of said optical micro-element.

2. The optical router of claim 1, wherein said micro-latch in one of said conditions maintains the operable state of said optical micro-element when electrical power is interrupted.

3. The optical router of claim 1, wherein said micro-latch includes at least one latching micro-element moving when said micro-latch changes conditions.

4. The optical router of claim 2, further comprising a micro-actuator operatively connected to said optical micro-element, said micro-actuator moving said optical micro-element to change the state thereof.

5. The optical router of claim 4, wherein said micro-actuator includes a micro-comb drive.

6. The optical router of claim 4, wherein said micro-actuator includes first and second portions movable with respect to each other in response to a drive signal;
said router further comprising:
a support supporting said micro-actuator;
at least one micro-spring having first and second ends operatively connected to respective first and second portions of said micro-actuator to bias said optical micro-element into a first one of said operable states in the absence of the drive signal.

7. The optical router of claim 6, wherein said latching micro-element selectively stops said micro-actuator in a second one of said operable states.

8. The optical router of claim 1, wherein said optical micro-element includes an optical beam reflecting surface.

9. The optical router of claim 8, wherein said reflecting surface is planar.

10. The optical router of claim 8, wherein said reflecting surface is concave.

11. The optical router of claim 1, comprising an optical micro-switch including said optical micro-element and said micro-latch.

12. The optical router of claim 11, comprising plural said optical micro-switches arranged in an M by N array, wherein at least one of M and N is greater than 1.

13. An optical router comprising:
at least one moveable optical micro-element having plural operable states, wherein a change in the operable state of said optical micro-element is accompanied by said optical micro-element moving in a direction defining a movement direction; and
a micro-actuator operatively connected to said optical micro-element, said micro-actuator arranged to effectuate the changing of the operable state of said optical micro-element,
wherein said optical micro-element is arranged in one of said states to intercept an optical beam supplied from a direction generally perpendicular to said reference direction and arranged in another said state to deflect said intercepted optical beam into another direction generally perpendicular to said reference direction.

14. The optical router of claim 13, wherein said optical micro-element includes an optical beam reflecting surface.

15. The optical router of claim 14, wherein said reflecting surface is planar.

16. The optical router of claim 14, wherein said reflecting surface is concave.

17. The optical router of claim 13, further comprising a micro-latch selectively actuatable to maintain said optical micro-element in one of said operable states;
said optical router comprising an optical micro-switch including said optical micro-element, said micro-actuator and said micro-latch.

18. The optical router of claim 17, comprising plural said optical micro-switches arranged in an M by N array, wherein at least one of M and N is greater than 1.

19. The optical router of claim 14, wherein said micro-actuator includes first and second portions movable with respect to each other in response to a drive signal;
said router further comprising:
a support supporting said micro-actuator;
at least one micro-spring having first and second ends operatively connected to respective first and second portions of said micro-actuator to bias said optical micro-element into a first one of said operable states in the absence of the drive signal.

20. A method for routing optical beams, said method comprising the steps:
a) selectively switching a optical micro-element between plural operable states to change the direction of an optical beam; and
b) selectively actuating a micro-latch to retain said optical micro-element in one of said operable states.

21. The method of claim 20, wherein a micro-actuator is operably connected to said optical micro-element, said step a) of selectively switching being effected by supplying a drive signal to said micro-actuator to move said micro-actuator between said plural operable states.

22. The method of claim 21 wherein said micro-actuator includes a vertical micro-comb drive.

23. The method of claim 21, further comprising:
c) biasing said micro-actuator with a micro-spring operatively connected across said micro-actuator to bias said optical micro-element into one of said plural operable states.

24. The method of claim 23, wherein said b) of actuating said micro-latch retains said optical micro-element into a said operable state despite a tension force supplied by said step c) of biasing.

25. The method of claim 20, wherein said optical micro-element is an optical beam reflecting surface.

26. A method for routing optical beams, said method comprising the steps:
a) providing an optical micro-element arranged to intercept an optical beam and being movable in a movement direction to route an optical beam from an input location along an input path to plural output locations;
b) providing a micro-actuator operatively connected to said optical micro-element to move said optical micro-element to switch between plural operable states routing the optical beam to said plural output locations;
c) selectively driving said micro-actuator to move said optical micro-element in a movement direction between the plural operable states to route the optical beam to the plural output locations;
said input path and the paths taken by said optical beam after routing by said optical element to said plural output locations being generally perpendicular to said movement direction.

27. The method of claim 26, wherein said optical micro-element is an optical beam reflecting surface.

28. The method of claim 26, wherein said micro-actuator includes first and second portions movable with respect to each other in response to a drive signal; said method further comprising:
d) biasing said micro-actuator with a micro-spring operatively connected across said micro-actuator to bias said optical micro-element into one of said plural operable states.

29. The method of claim 28 further comprising the step of:
e) selectively actuating a micro-latch to retain said optical micro-element in one of said operable states despite a tension force supplied by said step d) of biasing.
